(19) United States
(12) Patent Application Publication
(10) Pub. No.: US 2026/0103156 A1
(43) Pub. Date: Apr. 16, 2026

(54) ELECTRICAL ASSEMBLY

(71) Applicant: Lear Corporation, Southfield, MI (US)

(72) Inventors: Xavier Farre Vives, Valls (ES); Uemit Celiker, Schwelm (DE); Jordi Angel Serrano, Cologne (DE)

(73) Assignee: Lear Corporation, Southfield, MI (US)

(21) Appl. No.: 19/356,234

(22) Filed: Oct. 13, 2025

Related U.S. Application Data
(60) Provisional application No. 63/706,867, filed on Oct. 14, 2024.

(51) Int. Cl. B60R 16/027; B60N 2/879; B60R 16/02; H01R 13/627; H01R 13/631; H01R 43/26

(52) U.S. Cl. CPC B60R 16/027; B60N 2/879; B60R 16/0215; H01R 13/6272; H01R 13/631; H01R 43/26; H01R 2201/26

(57) ABSTRACT

A headrest assembly, comprising a headrest comprising a post; a guide sleeve configured to at least partially receive the post; and an electrical assembly comprising: a first connector configured to slide within the guide sleeve; a plurality of first terminals disposed at least partially in the first connector; a second connector configured to engage the first connector; a plurality of second terminals disposed at least partially in the second connector and configured to engage the plurality of first terminals; and a retainer slidably coupled with the second connector and configured to lock the first connector with the second connector.

### CROSS-REFERENCE TO RELATED APPLICATION

This application claims the benefit of and priority to U.S. Provisional Application 63/706,867 filed Oct. 14, 2024, the disclosure of which is hereby incorporated by reference in its entirety as though fully set forth herein.

### TECHNICAL FIELD

The present disclosure generally relates to electrical assemblies, including electrical assemblies that can, for example, be utilized in connection with headrests of vehicle seats.

### BRIEF DESCRIPTION OF THE DRAWINGS

While the claims are not limited to a specific illustration, an appreciation of various aspects may be gained through a discussion of various examples. The drawings are not necessarily to scale, and certain features may be exaggerated or hidden to better illustrate and explain an innovative aspect of an example. Further, the exemplary illustrations described herein are not exhaustive or otherwise limiting, and embodiments are not restricted to the precise form and configuration shown in the drawings or disclosed in the following detailed description. Exemplary illustrations are described in detail by referring to the drawings as follows:

FIG. 1 is a schematic view generally illustrating an embodiment of a seat assembly including a headrest assembly with an electrical assembly according to teachings of the present disclosure.

FIG. 2 is a schematic view generally illustrating an embodiment of a seat assembly including a headrest assembly with an electrical assembly according to teachings of the present disclosure.

FIG. 3 is an exploded perspective view generally illustrating an embodiment of an electrical assembly according to teachings of the present disclosure.

FIG. 4 is a perspective view generally illustrating an embodiment of a first connector according to teachings of the present disclosure.

FIG. 5 is a cross-sectional view generally illustrating an embodiment of a first connector with first terminals and first wires according to teachings of the present disclosure.

FIG. 6 is a perspective view generally illustrating an embodiment of a second connector according to teachings of the present disclosure.

FIG. 7 is a perspective view generally illustrating an embodiment of a retainer according to teachings of the present disclosure.

FIG. 8 is a cross-sectional view generally illustrating an embodiment of a retainer and a second connector with first terminals and first wires according to teachings of the present disclosure.

FIG. 9 is a perspective view generally illustrating an embodiment of a first connector, a second connector, and a retainer according to teachings of the present disclosure.

FIG. 10 is a cross-sectional view generally illustrating an embodiment of a first connector, a second connector, and a retainer, with the retainer in a pre-locked position, according to teachings of the present disclosure.

FIG. 11 is a cross-sectional view generally illustrating an embodiment of a first connector, a second connector, and a retainer, with the retainer in a locked position, according to teachings of the present disclosure.

FIG. 12 is a perspective view generally illustrating an embodiment of a first connector, a second connector, and a retainer, with the retainer in a locked position, according to teachings of the present disclosure.

FIG. 13 is a flow diagram generally illustrating an embodiment of a method of assembling a headrest assembly according to teachings of the present disclosure.

FIG. 14 is a perspective view generally illustrating an embodiment of an electrical assembly according to teachings of the present disclosure.

FIG. 15 is an exploded perspective view generally illustrating an embodiment of an electrical assembly according to teachings of the present disclosure.

FIG. 16 is an exploded perspective view generally illustrating an embodiment of a first connector and a second retainer according to teachings of the present disclosure.

FIGS. 17 and 18 are perspective view generally illustrating an embodiment of a first connector and a second retainer according to teachings of the present disclosure.

FIG. 19 is a front view generally illustrating an embodiment of a first connector and a second retainer according to teachings of the present disclosure.

FIG. 20 is an exploded perspective view generally illustrating an embodiment of a second connector, a first retainer, and a third retainer according to teachings of the present disclosure.

FIG. 21 is a perspective view generally illustrating an embodiment of a second connector, a first retainer, and a third retainer according to teachings of the present disclosure.

FIG. 22 is a front view generally illustrating an embodiment of a second connector, a first retainer, and a third retainer according to teachings of the present disclosure.

FIG. 23 is a cross-sectional view generally illustrating an embodiment of an electrical assembly, with the first retainer in a pre-locked position, according to teachings of the present disclosure.

FIG. 24 is a cross-sectional view generally illustrating an embodiment of an electrical assembly, with the first retainer in a locked position, according to teachings of the present disclosure.

FIG. 25 is a perspective view generally illustrating an embodiment of a first connector, a post, and an assembly tool according to teachings of the present disclosure.

### DETAILED DESCRIPTION

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

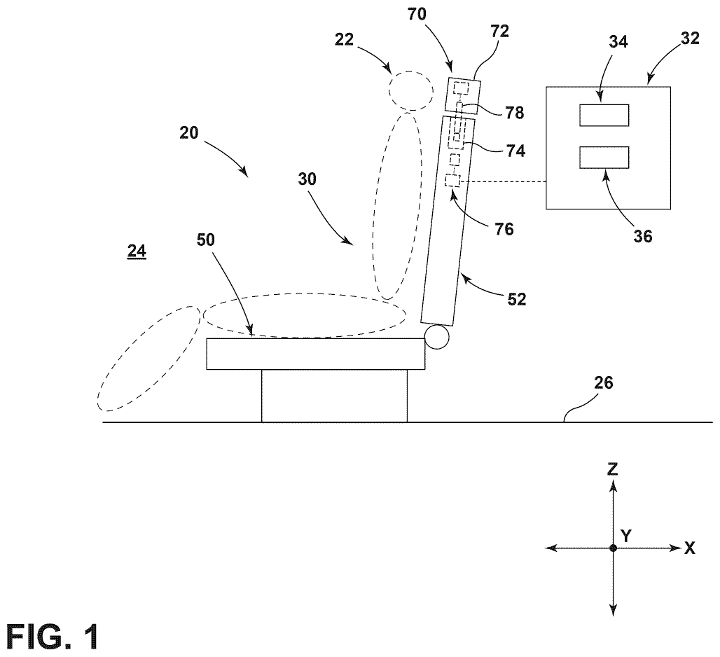

Referring to FIG. 1, a seat assembly 20 is illustrated with a seat 30 (e.g., a vehicle seat) and an electronic controller 32 including a processor 34 and a memory 36. The seat 30 is configured to support an occupant 22. The seat assembly 20 is illustrated as a vehicle seat assembly of a vehicle 24, but can be utilized in other applications. The seat 30 includes a seat base 50 and a seat back 52 coupled to the seat base 50. The seat 30 is coupled with a mounting surface 26, such as a floor of the vehicle 24. The seat assembly 20 defines a longitudinal direction X, a transverse direction Y, and a vertical direction Z.

The seat 30 includes a headrest assembly 70 coupled with the seat back 52. The headrest assembly 70 includes a headrest 72, a guide sleeve 74, and an electrical assembly 76. The headrest 72 includes a post 78 that is configured for insertion into and/or engagement with the guide sleeve 74. The guide sleeve 74 is coupled (e.g., fixed) with the seat back 52. For example, insertion of the post 78 into the guide sleeve 74 couples the headrest 72 with the seat back 52. Optionally, the headrest 72 includes more than one post 78, and a guide sleeve 74 for each post 78.

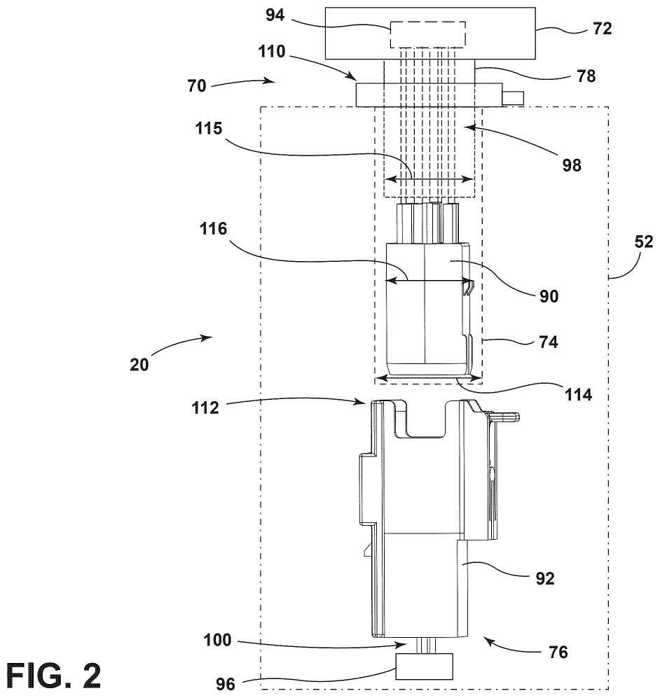

Referring to FIG. 2, the electrical assembly 76 includes a first connector 90, a second connector 92, headrest electrical components 94, and/or seat electrical components 96. The headrest electrical components 94 are coupled with and/or disposed at least partially in the headrest 72. Optionally, the headrest electrical components 94 include one or more of a speaker, a heater, a microphone, a motor, an airbag, or other electrical components. The seat electrical components 96 are disposed in the seat 30, such as in the seat base 50 and/or the seat back 52, and/or are connected to the seat 30. The seat electrical components 96 optionally include one or more of a power supply, a controller, such as the electronic controller 32, or other electrical components. The first connector 90 is electrically connected with the headrest electrical components 94, such as via a plurality of first wires 98. The second connector 92 is electrically connected to the seat electrical components 96 via a plurality of second wires 100. The first connector 90 and the second connector 92 are configured to engage (e.g., mechanically and electrically) each other, such as in a connection direction D, to electrically connect the headrest electrical components 94 with the seat electrical components 96. For example, the engagement of the first connector 90 with the second connector 92 can provide power to, allow for providing data to, and/or allow for receiving data from the headrest electrical components 94.

The first connector 90 is disposed at or beyond a distal end of the post 78 and is coupled (e.g., electrically) with the headrest 72 via the plurality of first wires 98, which extend through the post 78 to the headrest electrical components 94. For example, the first connector 90 is, optionally, not directly mechanically coupled with the post 78. The post 78 and the first connector 90 are configured to be inserted into a first end 110 of the guide sleeve 74 and to slide within the guide sleeve 74. The post 78 and the first connector 90 are movable in the guide sleeve 74 such that the first connector 90 extends at least partially beyond a second end 112 of the guide sleeve 74, such as to engage the second connector 92. The first end 110 of the guide sleeve 74 is disposed at or above a top of the seat back 52. The second end 112 is disposed inside the seat back 52. The guide sleeve 74 includes an inner diameter 114. Optionally, the inner diameter 114 is at least 15 mm and less than or equal to 17 mm, such as 16 mm. An outer diameter of the post 78 is less than the inner diameter 114 of the guide sleeve 74. An inner diameter 115 of the post 78 is, optionally, at least 8 mm and less than or equal to 10 mm. An outer diameter 116 of the first connector 90 is less than the inner diameter 114 and/or the inner diameter 115. For example, the outer diameter 116 is at least 14 mm and less than 16 mm, such as at least 15.3 mm and less than or equal to 15.7 mm (e.g., 15.5 mm). Additionally or alternatively, the outer diameter 116 is at least 13 mm and less than 16 mm, such as at least 13 mm and less than or equal to 14 mm (e.g., 13.5 mm).

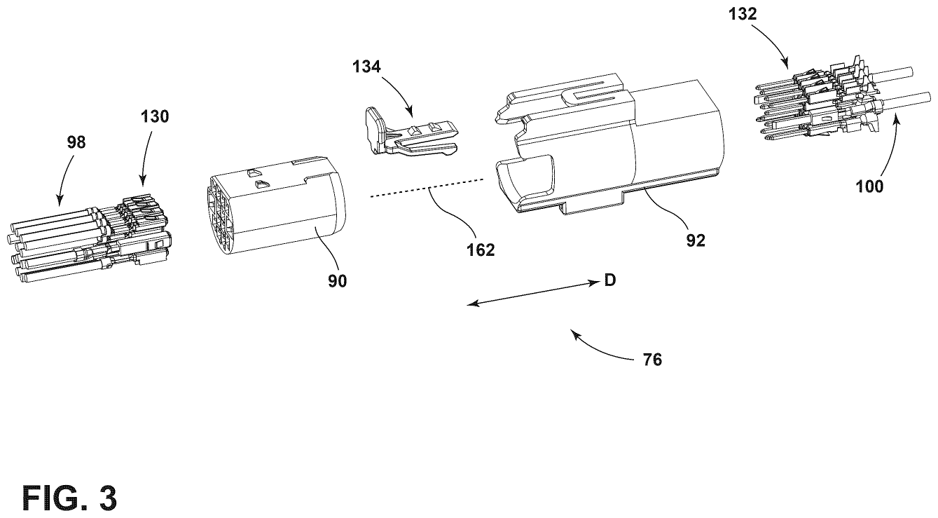

Referring to FIG. 3, an exploded view of the electrical assembly 76 is illustrated with the first connector 90, the second connector 92, the plurality of first wires 98 coupled with a plurality of first terminals 130 for insertion into the first connector 90, the plurality of second wires 100 coupled with a plurality of second terminals 132 for insertion into the second connector 92, and a retainer 134. The retainer 134 is slidably engageable with the second connector 92, such as to selectively lock the first connector 90 with the second connector 92. The plurality of first terminals 130 includes at least 8 first terminals, at least 10 first terminals, and/or less than or equal to 14 first terminals. In the illustrated example, the plurality of first terminals 130 includes 14 first terminals. In another example, the plurality of first terminals 130 includes 9 terminals. The plurality of second terminals 132 includes at least 8 second terminals, at least 10 second terminals, and/or less than or equal to 14 second terminals. In the illustrated example, the plurality of second terminals 132 includes 14 second terminals (e.g., the same number as the plurality of first terminals 130). In another example, the plurality of second terminals 132 includes 9 terminals. The plurality of first terminals 130 are provided as receiving terminals that define terminal receptacles that at least partially receive the plurality of second terminals 132, which are provided as protruding terminals (e.g., blades, pins, etc.). A reversed configuration or a combination configuration in which the plurality of second terminals 132 includes one or more receiving terminals can also be utilized. Optionally, at least one of the plurality of first terminals 130 is configured for use with higher electrical current than at least one other first terminal of the plurality of first terminals 130, such as to provide higher current to certain components of the headrest electrical components 94 (FIG. 2) or to provide a common ground. One or more corresponding second terminals 132 are also configured for use with such higher electrical currents.

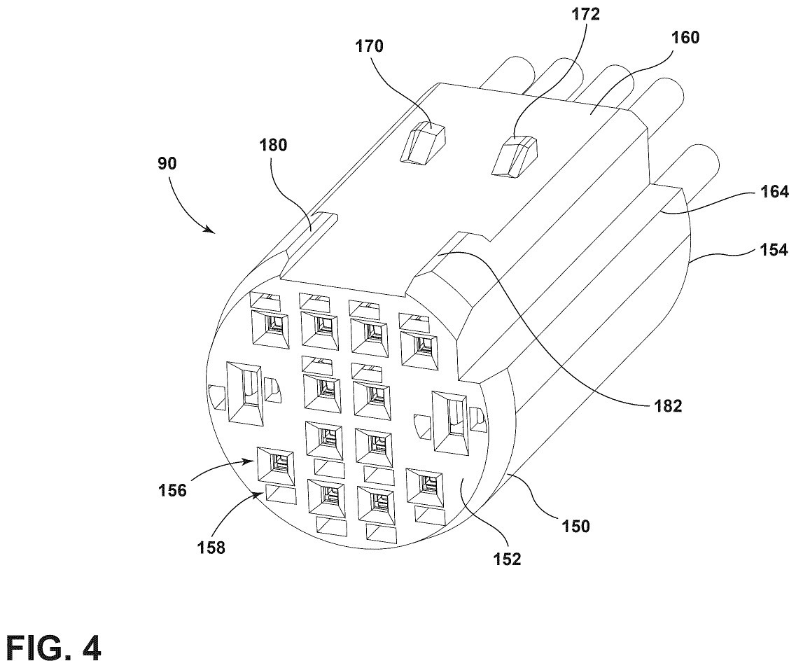

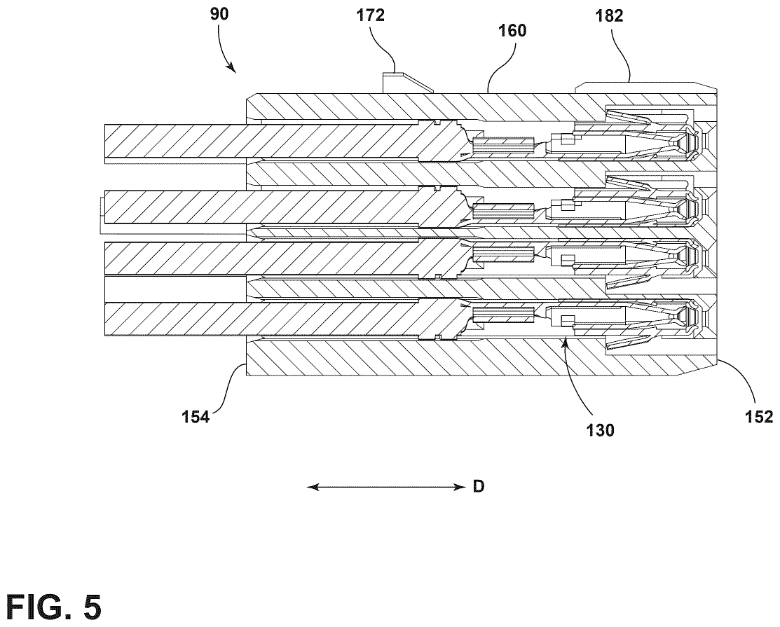

Referring to FIGS. 4 and 5, the first connector 90 is illustrated with a body 150 including a first surface 152 (e.g., a front surface) that faces the second connector 92 (FIG. 3) and a second surface 154 (e.g., a rear surface) into which the plurality of first terminals 130 (FIG. 5) are inserted. The body 150 includes a terminal aperture 156 for each of the plurality of first terminals 130 (FIG. 5), and a release aperture 158 for each of the plurality of first terminals 130. The terminal apertures 156 and the release apertures 158 extend to the first surface 152. The plurality of first terminals 130 (FIG. 5) are disposed at least partially in the terminal apertures 156, and the terminal apertures 156 are configured to receive portions of the plurality of second terminals 132, such as to facilitate insertion of the plurality of second terminals 132 (FIG. 3) into the plurality of first terminals 130. The body 150 includes a round configuration with a flat portion 160 that is parallel to a centerline 162 (FIG. 2) of the first connector 90. For example, the flat portion 160 faces radially outward and the round configuration corresponds to the shape of the guide sleeve 74. The body 150 includes an alignment recess 164 formed in an outer surface of the first connector 90 such that the alignment recess 164 opens radially outward. In the illustrated example, the alignment recess 164 extends from the first surface 152 to the second surface 154.

The first connector 90 includes a latch protrusion 170 that extends (e.g., radially outward) from the flat portion 160 and is axially offset from the first surface 152. Optionally, the first connector 90 includes a second latch protrusion 172 offset (e.g., circumferentially) from the latch protrusion 170. The first connector 90 includes a retainer protrusion 180 that extends radially outward from the flat portion 160 and extends axially to the first surface 152. Optionally, the first connector 90 includes a second retainer protrusion 182 offset (e.g., circumferentially) from the retainer protrusion 180.

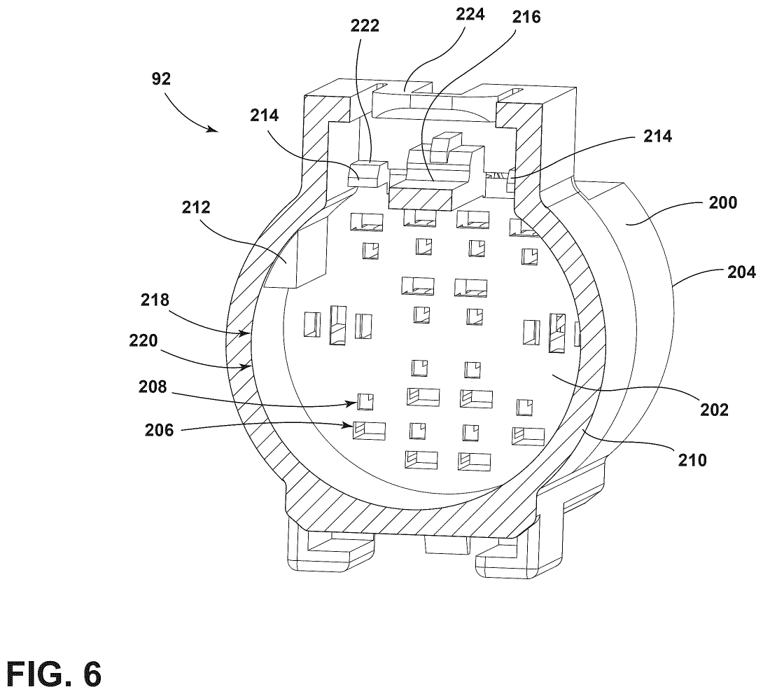

Referring to FIG. 6, the second connector 92 is illustrated with a body 200. The body 200 includes a first surface 202 that faces the first connector 90 (FIG. 2), a second surface 204 into which the plurality of second terminals 132 (FIG. 3) are inserted, a terminal aperture 206 for each of the plurality of second terminals 132, a release aperture 208 for each of the plurality of second terminals 132, a sleeve portion 210 that extends from the first surface 202 toward the first connector 90 (FIG. 2), an alignment protrusion 212, a stop surface 214, and a flexible latch 216 (e.g., a flexible retainer latch). The terminal apertures 206 and the release apertures 208 extend to the first surface 202. The plurality of second terminals 132 (FIG. 3) are disposed at least partially in the terminal apertures 206, and extend through the terminal apertures 206 into a space 218 defined at least partially by the sleeve portion 210. The sleeve portion 210 and the first surface 202 at least partially define the space 218 to form a receptacle 220 that at least partially receives the first connector 90. The alignment protrusion 212 corresponds to the alignment recess 164 of the first connector 90 (FIG. 4) and extends radially inward from the sleeve portion 210. The alignment protrusion 212 limits insertion of the first connector 90 into the second connector 92 to the proper orientation, which prevents improper connection. The stop surface 214 is provided at a distal end of one or more stop protrusions 222 that extend from the first surface 202 toward the first connector 90 (FIG. 2). The stop surface 214 is perpendicular to the connection direction D, which is parallel to the centerline 162 (FIG. 5) of the first connector 90. The stop surface 214 contacts the retainer 134 (FIG. 3), at least in some circumstances.

The flexible latch 216 extends from the first surface 202 toward the first connector 90 (FIG. 2). The flexible latch 216 is configured to flex radially outward and inward to slide over and engage the latch protrusion 170 and/or the second latch protrusion 172 of the first connector 90 to latch/lock the first connector 90 with the second connector 92. For example, as the first connector 90 is inserted into the receptacle 220, the flexible latch 216 contacts the flat portion 160 and/or the latch protrusions 170, 172, which causes the flexible latch 216 to flex radially outward and over the latch protrusions 170, 172. Once insertion of the first connector 90 is complete, the flexible latch 216 flexes back radially inward such that a portion of the flexible latch 216 is behind (e.g., closer to the second surface 154 of the first connector 90 than) the latch protrusions 170, 172, latching the first connector 90 with the second connector 92. In the illustrated example, the flexible latch includes a T-shaped configuration.

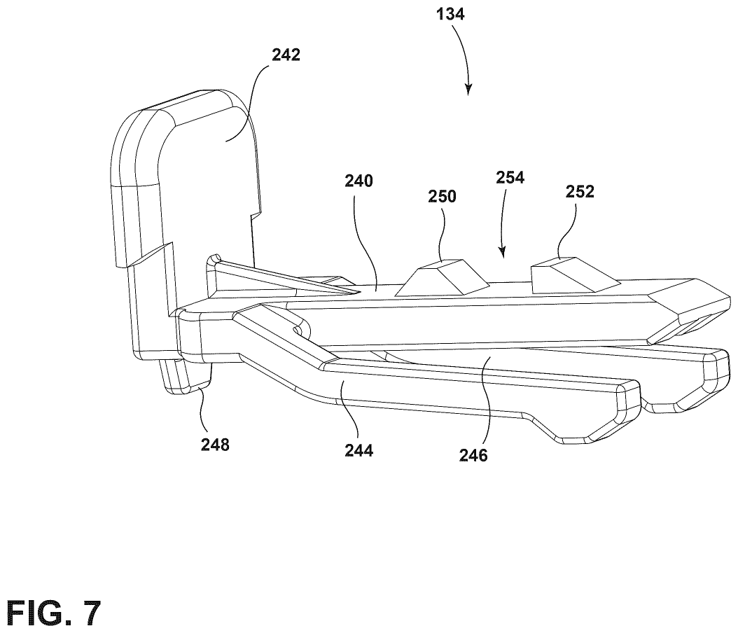

Referring to FIGS. 6 and 7, the second connector 92 includes a retainer latch 224. The retainer latch 224 engages the retainer 134 (FIG. 3) to restrict sliding movement of the retainer 134, such as to maintain the retainer 134 in a pre-locked position or a locked position. In the illustrated example, the retainer latch 224 includes a U-shaped configuration and is disposed at least partially radially outward of the flexible latch 216.

Referring to FIG. 7, the retainer 134 is illustrated with a body 240, a tab 242, a retainer arm 244 (e.g., a first retainer arm), a second retainer arm 246, and a connector projection 248. The tab 242 extends (e.g., radially outward) from the body 240 to facilitate a user sliding the retainer 134, such as into initial engagement with the second connector 92 and/or between the pre-locked and locked positions. The retainer arms 244, 246 are flexible and extend (e.g., generally in the connection direction D) from the body 240 and are configured to contact the stop surface 214. The retainer arms 244, 246 are configured to flex/deflect in the radial direction, such as radially outward and at least partially out of alignment with the stop surface 214 via contact with the retainer protrusions 180, 182 with insertion of the first connector 90 (FIG. 3). The connector projection 248 extends (e.g., radially inward) from the body 240, such as opposite the tab 242. With the retainer 134 in the locked position, the connector projection 248 restricts and/or prevents outward movement of the flexible latch 216 of the second connector 92 (FIG. 6), which prevents removal of the first connector 90 from the second connector 92 (FIG. 3).

The retainer 134 includes a first latch projection 250 and a second latch projection 252 that extend (e.g., radially outward) from the body 240 to engage the retainer latch 224 of the second connector 92 (FIG. 6). The latch projections 250, 252 are spaced from each other in the connection direction D, with the first latch projection closer to the tab 242. The latch projections 250, 252 define a space 254 (e.g., a recess) therebetween configured to receive portions of the retainer latch 224. For example, in the pre-locked position of the retainer 134, the retainer latch 224 is disposed partially in the space 254. The first latch projection 250 is ramped at a front side and a rear side, such as to facilitate sliding movement of the retainer 134 between the pre-locked and locked positions (e.g., via deflecting the retainer latch 224 outward). The second latch projection 252 is ramped at a rear side to facilitate initial engagement/insertion of the retainer 134 with the second connector 92. A forward surface of the second latch projection 252 is perpendicular to the connection direction D, which prevents removal of the retainer 134 from the second connector 92 without separate deflection (e.g., by a user) of the retainer latch 224.

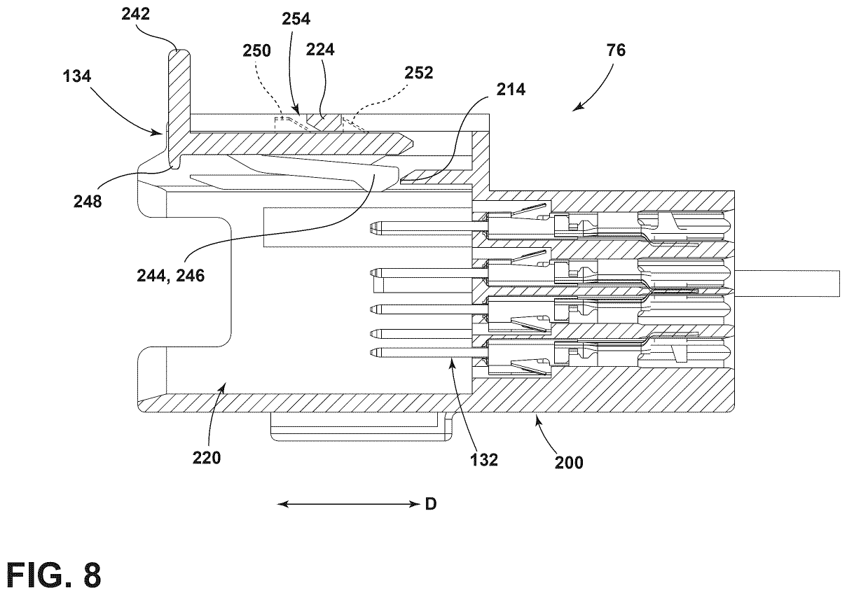

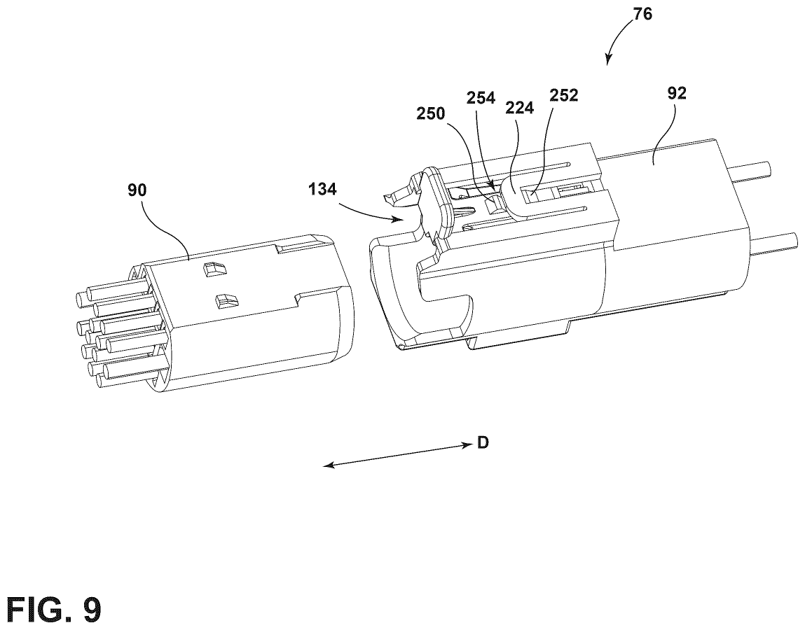

Referring to FIGS. 8 and 9, the retainer 134 is shown in the pre-locked position with the second connector 92, prior to insertion of the first connector 90 into the second connector 92. In the pre-locked position, the retainer 134 is connected with the second connector 92 with the retainer arms 244, 246 in contact with the stop surface 214 and the retainer latch 224 in the space 254. The plurality of second terminals 132 are disposed partially in the body 200 and partially in the receptacle 220.

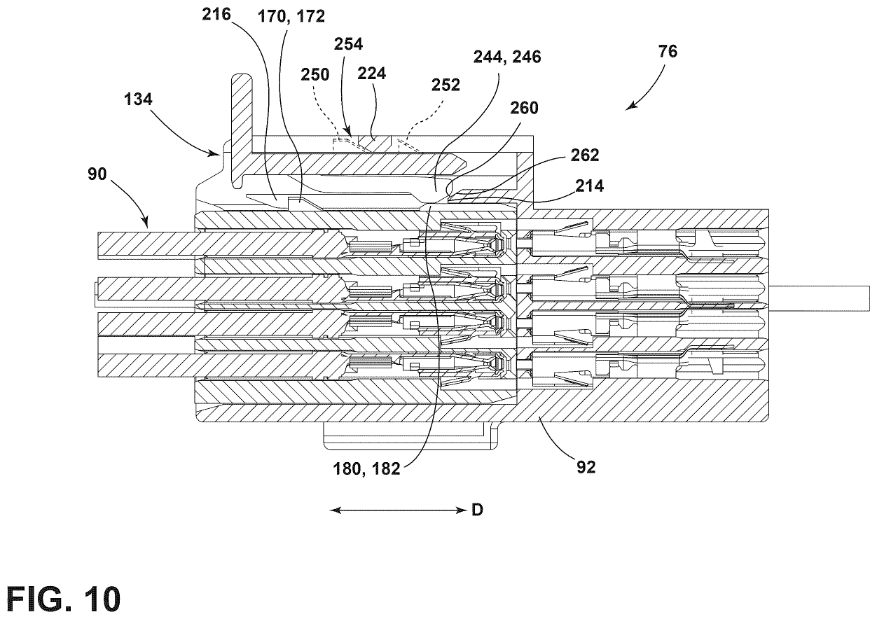

Referring to FIG. 10, the retainer 134 is shown in the pre-locked position with the second connector 92, with the first connector 90 inserted into the second connector 92, the flexible latch 216 latched with the latch protrusions 170, 172, and the plurality of first terminals 130 engaged/mated with the plurality of second terminals 132. The retainer 134 is connected with the second connector 92 with the retainer arms 244, 246 in contact with the retainer protrusions 180, 182 such that the retainer arms 244, 246 are at least partially out of alignment with the stop surface 214. For example, corresponding ramped surfaces 260, 262 of the retainer arms 244, 246 and the one or more stop protrusions 222, respectively, are at least partially aligned such that further insertion of the retainer 134 will cause the retainer arms 244, 246 to deflect outward.

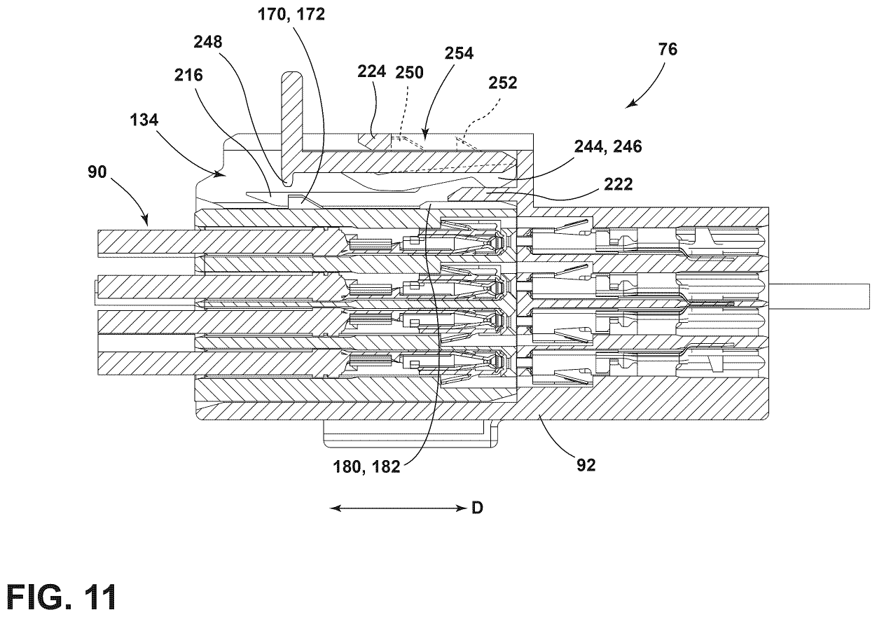

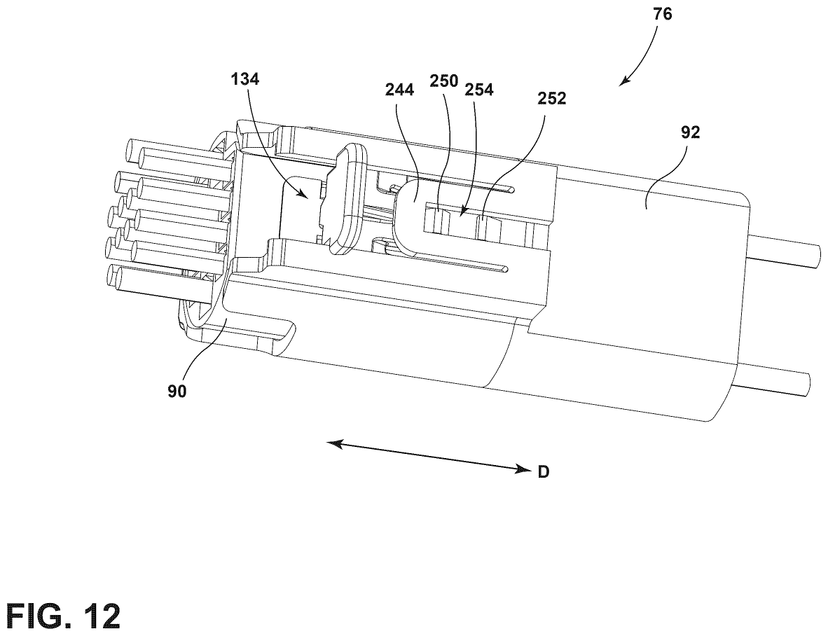

Referring to FIG. 11, the retainer 134 is shown in the locked position with the second connector 92 such that the connector projection 248 restricts or prevents disengagement of the flexible latch 216 from the latch protrusions 170, 172. Portions of the retainer arms 244, 246 are disposed on the one or more stop protrusions 222. FIG. 12 is a perspective view of the configuration illustrated in FIG. 11.

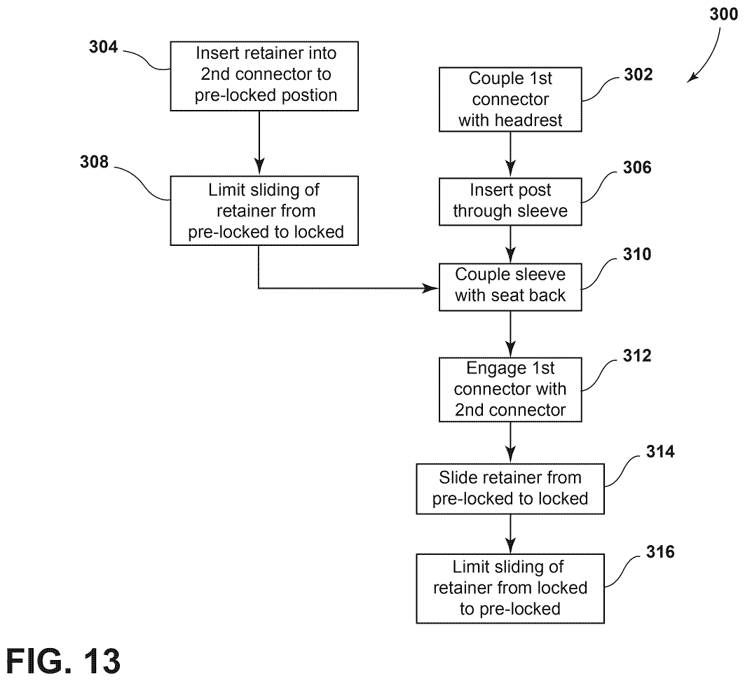

Referring to FIG. 13, a method 300 of assembling the headrest assembly 70 includes providing the first connector 90 (block 302), which can include coupling the plurality of first wires 98 with the plurality of first terminals 130 and/or coupling (e.g., inserting) the plurality of first terminals 130 into the first connector 90. The method 300 includes inserting the retainer 134 into the second connector 92 to the pre-locked position (block 304). The method 300 includes inserting the post 78 and, optionally, the first connector 90 into the first end 110 of the guide sleeve 74 such that the first connector 90 is disposed at least partially beyond the second end 112 of the guide sleeve 74 (block 306). In some configurations, providing the first connector 90 in block 302 is conducted after the post 78 is inserted into and/or through the guide sleeve 74 in block 306. For example, in such configurations, the plurality of first wires 98, which may already be coupled with the plurality of first terminals 130, are inserted through the post 78 such that the plurality of first wires 98 and/or the plurality of first terminals 130 extend beyond the distal end of the post 78 for insertion into the first connector 90, and inserting the post 78 into the guide sleeve 74 includes inserting the plurality of first wires 98 through the guide sleeve 74 such that portions of the plurality of first wires 98 extend beyond the second end 112 of the guide sleeve 74.

The method 300 includes limiting (e.g., preventing) sliding of the retainer 134 from the pre-locked position to the locked position (block 308), such as via contact between the retainer arms 244, 246 and the stop surface 214 of the second connector 92. The method 300 includes coupling the guide sleeve 74 with the seat back 52 (block 310), and engaging the first connector 90 with the second connector 92 (block 312). The method 300 includes sliding the retainer 134 from a pre-locked position to a locked position to lock the first connector 90 with the second connector 92 (block 314), and limiting sliding movement of the retainer 134 from the locked position to the pre-locked position (block 316), such as via contact between the retainer 134 and a latch (e.g., the retainer latch 224) of the second connector 92. Optionally, engaging the first connector 90 with the second connector 92 in block 312 includes inserting the plurality of second terminals 132 into the plurality of first terminals 130, and/or the first connector 90 deflecting an arm (e.g., one or both of retainer arms 244, 246) of the retainer 134 to facilitate the sliding of the retainer 134 to the locked position.

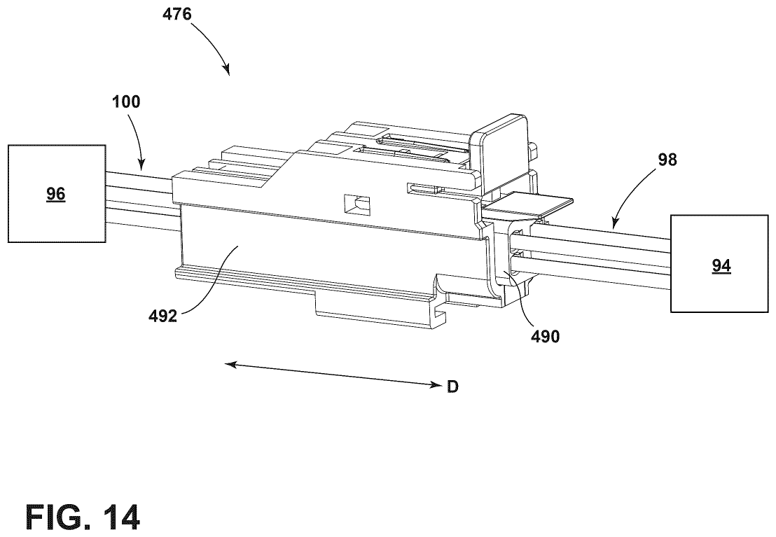

Referring to FIG. 14, an electrical assembly 476 is illustrated that can be utilized with the seat assembly 20 of FIG. 1. The electrical assembly 476 includes a first connector 490, a second connector 492, the headrest electrical components 94, and/or the seat electrical components 96. The first connector 490 is electrically connected with the headrest electrical components 94, such as via the plurality of first wires 98. The second connector 492 is electrically connected to the seat electrical components 96 via the plurality of second wires 100. The first connector 490 and the second connector 492 are configured to engage (e.g., mechanically and electrically) each other, such as in the connection direction D, to electrically connect the headrest electrical components 94 with the seat electrical components 96. For example, the engagement of the first connector 490 with the second connector 492 can provide power to, allow for providing data to, and/or allow for receiving data from the headrest electrical components 94 (FIG. 2).

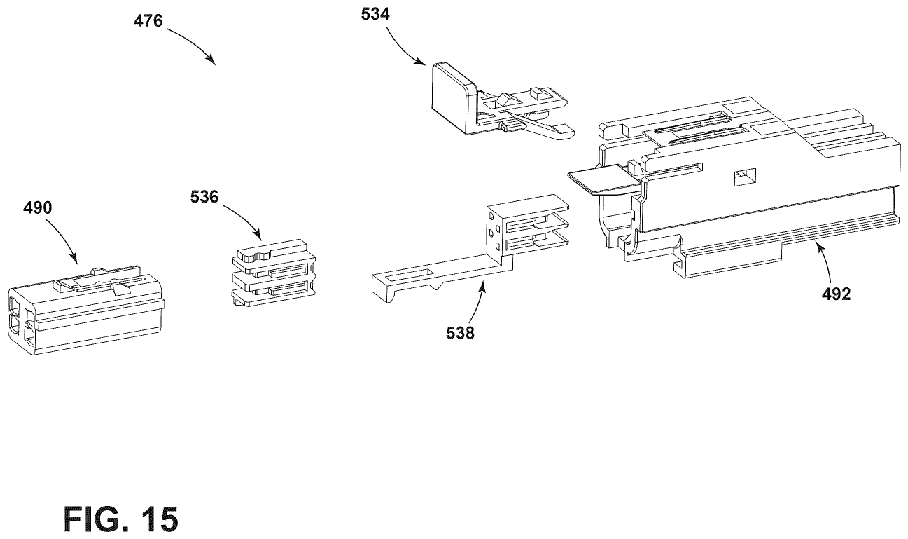

Referring to FIG. 15, an exploded view of the electrical assembly 476 is illustrated with the first connector 490, the second connector 492, a first retainer 534, a second retainer 536, and a third retainer 538. The first retainer 534 is slidably engageable with the second connector 492, such as to selectively lock and/or assure the relative positions of the first connector 490 with the second connector 492. The first connector 490 is configured to receive the plurality of first terminals 130 (FIG. 3), which includes, for example, at least two first terminals and less than or equal to six first terminals, such as four first terminals. The second retainer 536 is slidably engageable with the first connector 490, such as to selectively lock and/or assure the position of the plurality of first terminals 130 relative to the first connector 490. The second connector 492 is configured to receive the plurality of second terminals 132 (FIG. 3), which includes, for example, four second terminals (e.g., the same number as the plurality of first terminals 130). The third retainer 538 is slidably engageable with the second connector 492, such as to selectively lock and/or assure the position of the plurality of second terminals 132 (FIG. 3) relative to the second connector 492.

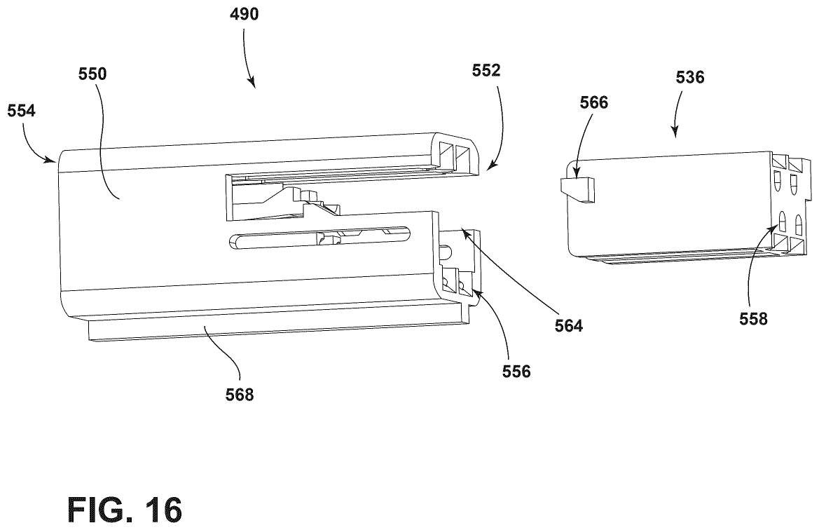

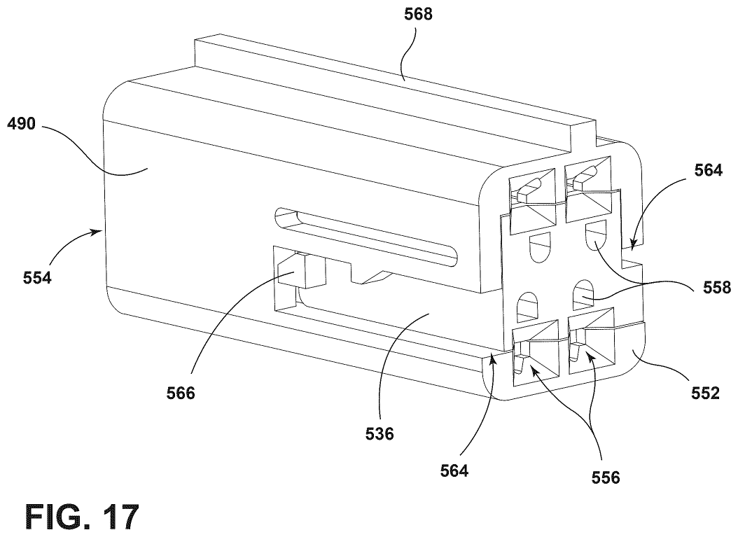

Referring to FIGS. 16 and 17, the first connector 490 and the second retainer 536 are illustrated. The first connector 490 is illustrated with a body 550 including a first surface 552 (e.g., a front surface) that faces the second connector 492 (FIG. 15) and a second surface 554 (e.g., a rear surface) into which the plurality of first terminals 130 (FIG. 3) are inserted. The body 550 defines at least a portion of a terminal aperture 556 for each of the plurality of first terminals 130 (FIG. 3). The second retainer 536 defines a release aperture 558 for each of the plurality of first terminals 130. In the illustrated example, the second retainer 536 defines a portion of the terminal apertures 556 (e.g., the body 550 and the second retainer 536 cooperate to define the terminal apertures 556). The terminal apertures 156 and the release apertures 158 extend to the first surface 552. The plurality of first terminals 130 (FIG. 3) are inserted at least partially into the terminal apertures 556, and the terminal apertures 556 are configured to receive portions of the plurality of second terminals 132 (FIG. 3), such as to facilitate insertion of the plurality of second terminals 132 (FIG. 3) into the plurality of first terminals 130. The body 550 includes one or more alignment recesses 564 that correspond to one or more alignment protrusions 566 of the second retainer 536. The body 550 includes an alignment rib 568 that extends along an outer surface of the body 550, such as from the first surface 552 to the second surface 554.

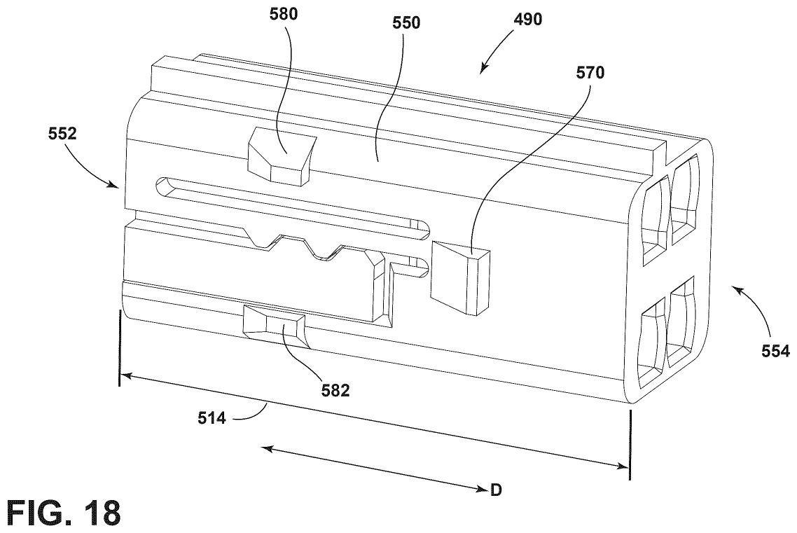

Referring to FIG. 18, the first connector 490 includes a latch protrusion 570 that extends (e.g., outward) from the body 550 and is axially offset from the first surface 552. In the illustrated example, the latch protrusion 570 includes a ramped configuration. The first connector 490 includes a retainer protrusion 580 that extends radially outward from the body 550. Optionally, the first connector 490 includes a second retainer protrusion 582 offset from the retainer protrusion 580. Optionally, a length 514 of the first connector 490 (e.g., in the connection direction D) is at least 15 mm and/or less than or equal to 18 mm. Limiting the length 514 can facilitate use of the first connector 490 with curved posts 78, such as by allowing the first connector 490 to slide through 90 degree bends in the post 78.

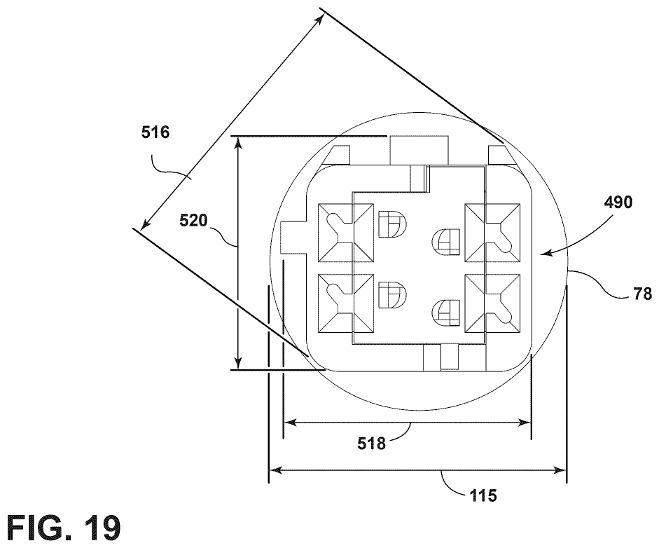

Referring to FIG. 19, an outer diameter 516 of the first connector 490 is less than the and the inner diameter 115 of the post 78. For example, the outer diameter 516 is greater than 7 mm and less than 10 mm for inner diameters 115 of 10 mm, or less than 9 mm for inner diameters 115 of 9 mm. Optionally, the first connector 490 has a rounded rectangular cross-section with a first dimension 518 (e.g., a width) and a second dimension 520 (e.g., a height). The first dimension 518 and the second dimension 520 are perpendicular to each other and the connection direction D. In some examples, a maximum of the first dimension 518 can be at least 7 mm and less than or equal to 8.5 mm, such as 7.8 mm. In some examples, a maximum of the second dimension 520 can be at least 6.5 mm and less than or equal to 8 mm, such as 7.3 mm.

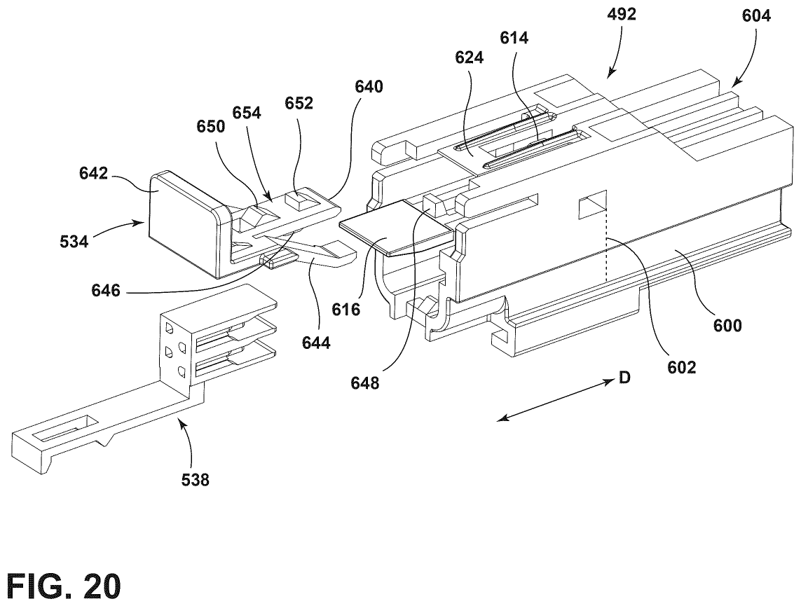

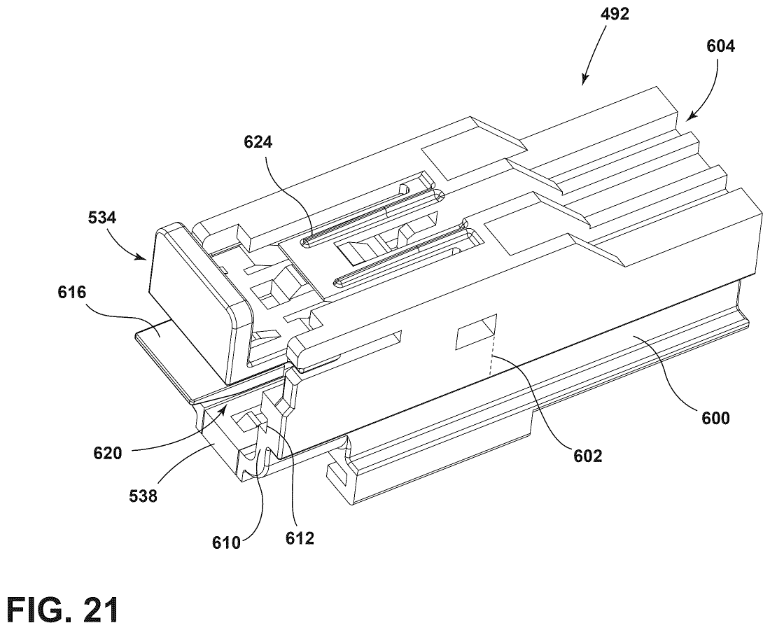

Referring to FIGS. 20 and 21, the second connector 492, the first retainer 534, and the third retainer 538 are illustrated. The second connector 492 is illustrated with a body 600. The body 600 includes a first surface 602 that faces the first connector 490 (FIG. 15), a second surface 604 into which the plurality of second terminals 132 (FIG. 3) are inserted. The second connector 492 includes a retainer latch 624. The retainer latch 624 engages the first retainer 534 to restrict sliding movement of the first retainer 534, such as to maintain the first retainer 534 in a pre-locked position or a locked position. In the illustrated example, the retainer latch 624 includes a U-shaped configuration and is disposed outward of the flexible latch 616.

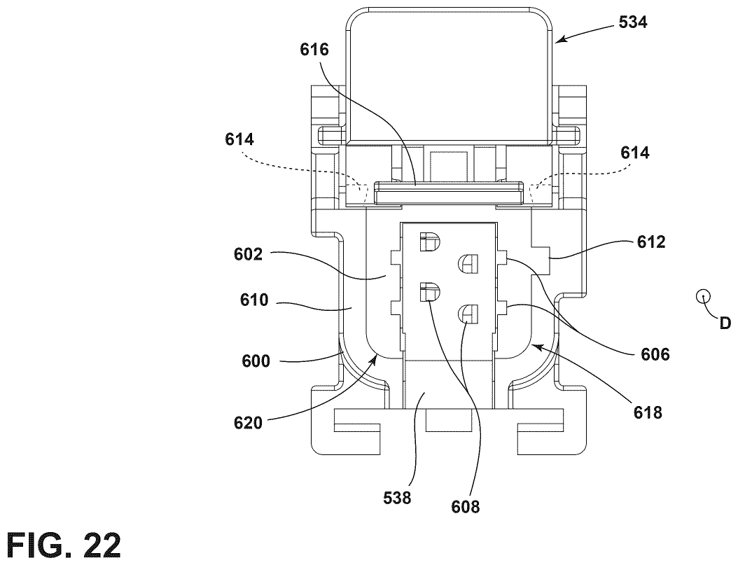

Referring to FIG. 22, the body 600 at least partially defines a terminal aperture 606 for each of the plurality of second terminals 132 (FIG. 3). The third retainer 538 defines a release aperture 608 for each of the plurality of second terminals 132. The body 600 defines a sleeve portion 610 that extends from the first surface 602 toward the first connector 490 (FIG. 15), an alignment recess 612, a stop surface 614, and a flexible latch 616 (e.g., a flexible retainer latch). The terminal apertures 606 and the release apertures 608 extend to the first surface 602. The plurality of second terminals 132 (FIG. 3) are insertable at least partially into the terminal apertures 606, and extend through the terminal apertures 606 into a space 618 defined at least partially by the sleeve portion 610. The sleeve portion 610 and the first surface 602 at least partially define the space 618 to form a receptacle 620 that at least partially receives the first connector 490 (FIG. 15). The alignment recess 612 corresponds to the alignment rib 568 of the first connector 490 (FIG. 18) and opens inward from the sleeve portion 610. The alignment recess 612 limits insertion of the first connector 490 (FIG. 15) into the second connector 492 to the proper orientation, which prevents improper connection. The stop surface 614 limits insertion of the first retainer 534, such as by preventing movement of the first retainer 534 from the pre-locked position to the locked position without the first connector 490 (FIG. 15) fully connected with the second connector 492. The stop surface 614 is, for example, perpendicular to the connection direction D and includes a first portion at a first side of the body 550 and a second portion at a second side of the body 550 (e.g., on opposite sides of the flexible latch 616).

The flexible latch 616 extends from the body 600, such as from the first surface 602 toward the first connector 490 (FIG. 15). The flexible latch 616 is configured to flex outward and inward to slide over and engage the latch protrusion 570 of the first connector 490 (FIG. 15) to latch/lock the first connector 490 with the second connector 492. For example, as the first connector 490 (FIG. 15) is inserted into the receptacle 620, the flexible latch 616 contacts the latch protrusion 570, which causes the flexible latch 616 to flex outward and over the latch protrusion 570. Once insertion of the first connector 490 is complete, the flexible latch 616 flexes back inward such that a portion of the flexible latch 616 is behind (e.g., closer to the second surface 554 of the first connector 490 than) the latch protrusion 570, latching the first connector 490 with the second connector 492. In the illustrated example, the flexible latch 616 includes a U-shaped configuration.

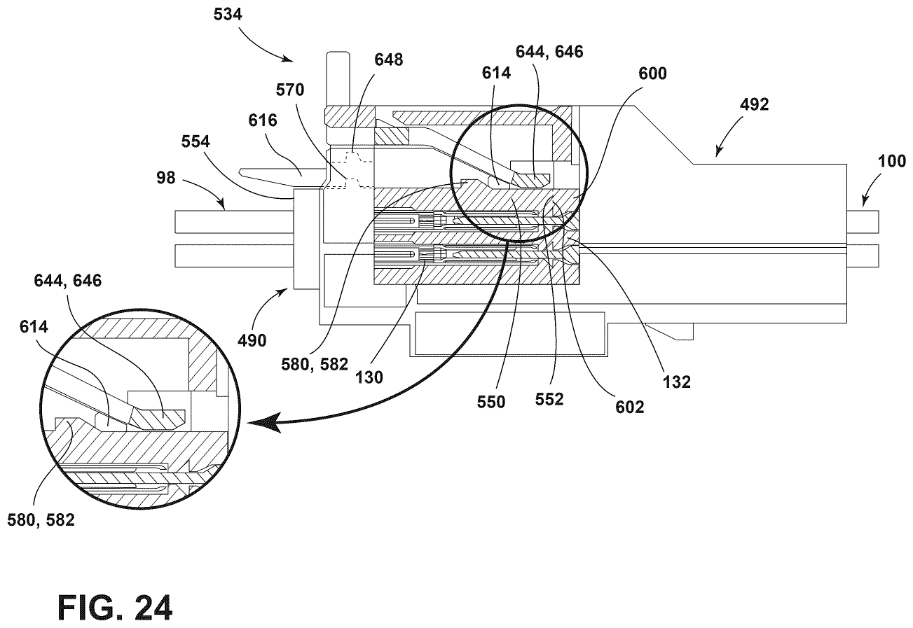

Referring again to FIG. 20, the first retainer 534 is illustrated with a body 640, a tab 642, a retainer arm 644 (e.g., a first retainer arm), a second retainer arm 646. The tab 642 extends (e.g., outward) from the body 640 to facilitate a user sliding the first retainer 534, such as into initial engagement with the second connector 492, and/or between the pre-locked and locked positions. The retainer arms 644, 646 are flexible and extend (e.g., generally in the connection direction D) from the body 640 and are configured to contact the stop surface 614. The retainer arms 644, 646 are configured to flex/deflect inward and outward, such as outward and at least partially out of alignment with the stop surface 614 via contact with the retainer protrusions 580, 582 with insertion of the first connector 490 (FIG. 15). The second connector 492 includes, for example, a connector projection 648, such as instead of the first retainer 534 including the projection (e.g., projection 248 of FIG. 7). The connector projection 648 extends from the flexible latch 616. With the first retainer 534 in the locked position (FIG. 24), the connector projection 648 is in contact and/or aligned with an inner surface of the first retainer 534 such that the connector projection 648 restricts and/or prevents outward movement of the flexible latch 616 of the second connector 492, which prevents removal of the first connector 490 (FIG. 15) from the second connector 492 (e.g., without first moving the first retainer 534 from the locked position to the pre-locked position).

The first retainer 534 includes a first latch projection 650 and a second latch projection 652 that extend from the body 640 to engage the retainer latch 624 of the second connector 492. The latch projections 650, 652 are spaced from each other in the connection direction D, with the first latch projection closer to the tab 642. The latch projections 650, 652 define a space 654 (e.g., a recess) therebetween configured to receive portions of the retainer latch 624. For example, in the pre-locked position of the first retainer 534 (see, e.g., FIG. 21), the retainer latch 624 is disposed partially in the space 654. The first latch projection 650 is ramped at a front side and a rear side, such as to facilitate sliding movement of the first retainer 534 between the pre-locked and locked positions (e.g., via deflecting the retainer latch 624 outward). The second latch projection 652 is ramped at a rear side to facilitate initial engagement/insertion of the first retainer 534 with the second connector 92 (e.g., initial movement of the first retainer 534 into the pre-locked position). A forward surface of the second latch projection 652 is perpendicular to the connection direction D, which prevents removal of the first retainer 534 from the second connector 492 without separate deflection (e.g., by a user) of the retainer latch 624.

Referring again to the example illustrated in FIG. 21, the first retainer 534 is shown in the pre-locked position with the second connector 492, prior to insertion of the first connector 490 (FIG. 14) into the second connector 492. In the pre-locked position, the first retainer 534 is connected with the second connector 492 with the retainer arms 644, 646 in contact with the stop surface 614 and the retainer latch 624 in the space 654. The plurality of second terminals 132 (FIG. 3) are disposed partially in the body 600 and partially in the receptacle 620.

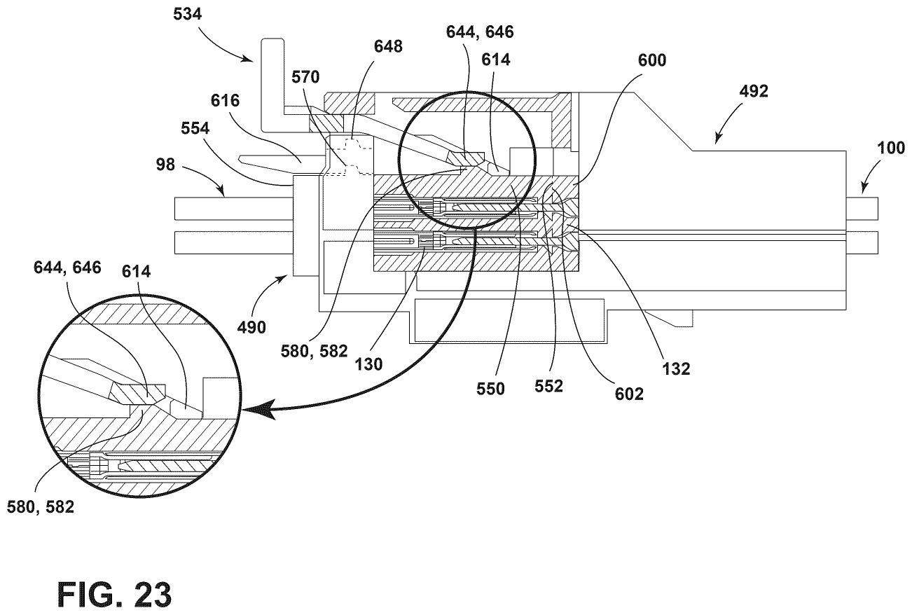

Referring to FIG. 23, the first retainer 534 is shown in the pre-locked position with the second connector 492, with the first connector 490 inserted into the second connector 492, the flexible latch 616 latched with the latch protrusion 570, and the plurality of first terminals 130 engaged/mated with the plurality of second terminals 132. The first retainer 534 is connected with the second connector 492 with the retainer arms 644, 646 in contact with the retainer protrusions 580, 582 such that the retainer arms 644, 646 are at least partially out of alignment with the stop surface 614. For example, corresponding ramped surfaces of the retainer arms 644, 646 and the stop surface 614, respectively, are at least partially aligned such that further insertion of the first retainer 534 will cause the retainer arms 644, 646 to deflect outward and over the stop surface 614.

Referring to FIG. 24, the first retainer 534 is shown in the locked position with the second connector 492 such that the connector projection 648 restricts or prevents disengagement of the flexible latch 616 from the latch protrusion 570. Portions of the retainer arms 644, 646 are disposed proximate or in contact with the first surface 602.

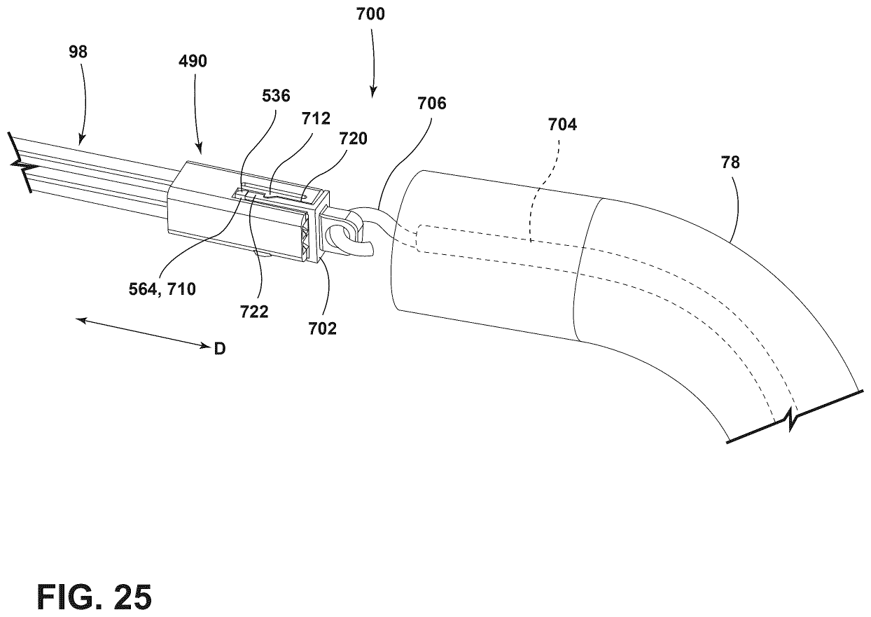

Referring to FIG. 25, an assembly tool 700 is illustrated with the first connector 490 and an example of the post 78. The assembly tool 700 includes a clip 702 and a wire 704. In the illustrated example, the wire 704 is attached to a hook 706 that is engaged with the clip 702. In other examples, the clip 702 and the wire 704 are integrally formed. The clip 702, the wire 704, and the hook 706 are configured (e.g., sized) to slide through the post 78, such as for pulling (e.g., feeding, guiding, etc.) the first connector 490 through the post 78.

The first connector 490 and the clip 702 include corresponding engagement formations such that the clip 702 can be selectively engaged with the first connector 490 and pulling on the wire 704 pulls the first connector 490 (e.g., through the post 78). In the illustrated example, the first connector 490 includes a recess 710, which can be one of the alignment recesses 564, and a first tooth 712 that extends into the recess 710. The clip 702 includes an arm 720 that extends into the recess 710 (e.g., in the connection direction D) and includes a second tooth 722 that extends from the arm 720 to engage the first tooth 712 to restrict relative movement between the first connector 490 and the clip 702. The clip 702 is disengaged from the first connector 490 after pulling the first connector 490 through the post 78, such as to couple the first connector 490 with the second connector 492 (FIG. 14). The clip 702 can be coupled with the first connector 490 after the plurality of first terminals 130 (FIG. 3) and the second retainer 536 are inserted into the first connector 490 (e.g., with the fist connector 490 in an assembled configuration), such that pulling the first connector 490 through the post 78 also pulls the plurality of first terminals 130 and the plurality of first wires 98 through the post 78.

The method 300 illustrated in FIG. 3 is described in connection with the first connector 90 and the second connector 92, but the method 300 can be conducted in a similar manner with the first connector 490 and the second connector 492.

Embodiments of headrest assemblies (e.g., headrest assembly 70) and/or electrical assemblies (e.g., electrical assembly 76) may provide increased functionality and/or allow for less complicated assembly and disassembly compared with other designs. For example, providing 10-14 first terminals in the first connector 90 can allow for increased functionality and/or control of the headrest assembly 70 (e.g., heaters, speakers, motors, microphones, etc.). Additionally or alternatively, configuring the first connector 90 to be slidable through the guide sleeve 74 can allow for the first connector 90 to be preassembled with the post 78 and/or allow for disconnection of the headrest 72 from the seat back 52 without disengaging the first terminals 130 from the first connector 90, which can facilitate service and maintenance processes and limit assembly errors. Including the retainer 134 can facilitate proper insertion of the first connector 90 into the second connector 92, and limit unintended disconnection of the first connector 90 from the second connector 92. Additionally or alternatively, configuring the first connector 490 to be slidable through the post 78 can allow for the first connector 490 to be preassembled with the post 78 and/or allow for disconnection of the headrest 72 from the seat back 52 without disengaging the first terminals 130 from the first connector 490, which can facilitate service and maintenance processes and limit assembly errors.

While electrical assemblies, such as electrical assemblies 76 and 476, and the connectors thereof, such as connectors 90, 92, 490, 492, are described in connection with a headrest assembly, the electrical assemblies and connectors can be utilized with other applications, including vehicle applications (e.g., sun visors, mirrors, cameras, etc.), among others.

The instant disclosure includes the following non-limiting embodiments:

An electrical assembly comprising: a first connector configured to slide within the guide sleeve; a plurality of first terminals disposed at least partially in the first connector; a second connector configured to engage the first connector; a plurality of second terminals disposed at least partially in the second connector and configured to engage the plurality of first terminals; and a retainer slidably coupled with the second connector and configured to lock the first connector with the second connector.

A headrest assembly, comprising: a headrest comprising a post; a guide sleeve configured to at least partially receive the post; and an electrical assembly comprising: a first connector configured to slide within the guide sleeve; a plurality of first terminals disposed at least partially in the first connector; a second connector configured to engage the first connector; a plurality of second terminals disposed at least partially in the second connector and configured to engage the plurality of first terminals; and a retainer slidably coupled with the second connector and configured to lock the first connector with the second connector.

A headrest assembly, comprising: a headrest comprising a post; a guide sleeve configured to at least partially receive the post; and an electrical assembly comprising: a first connector configured to slide within the guide sleeve; a plurality of first terminals disposed at least partially in the first connector; a second connector configured to engage the first connector; a plurality of second terminals disposed at least partially in the second connector and configured to engage the plurality of first terminals; and a retainer slidably coupled with the second connector and configured to lock the first connector with the second connector.

The headrest assembly of any preceding embodiment, wherein the first connector is configured to slide within the post.

The headrest assembly of any preceding embodiment, further comprising: a second retainer disposed at least partially in the first connector and restricting movement of the plurality of first terminals relative to the first connector; and a third retainer disposed at least partially in the second connector and restricting movement of the plurality of second terminals relative to the second connector.

The headrest assembly of any preceding embodiment, wherein an outer diameter of the first connector is less than an inner diameter of the post.

The headrest assembly of any preceding embodiment, wherein the outer diameter of the first connector is less than 10 mm and greater than or equal to 7 mm.

The headrest assembly of any preceding embodiment, wherein the plurality of first terminals includes four first terminals.

The headrest assembly of any preceding embodiment, wherein the retainer includes a pre-locked position and a locked position; the retainer includes a flexible arm; and the second connector includes a stop surface configured to contact the flexible arm to restrict movement of the retainer from the pre-locked position to the locked position.

The headrest assembly of any preceding embodiment, wherein the first connector includes a latch protrusion; and the second connector includes a flexible latch configured to engage the latch protrusion to latch the first connector with the second connector.

The headrest assembly of any preceding embodiment, wherein the retainer or the second connector includes a projection; and in the locked position of the retainer, the projection restricts disengagement of the flexible latch from the latch protrusion.

The headrest assembly of any preceding embodiment, wherein the first connector includes a retainer protrusion configured to deflect the flexible arm at least partially out of alignment with the stop surface to facilitate sliding movement of the retainer from the pre-locked position to the locked position.

The electrical assembly of any preceding embodiment.

A seat assembly comprising the headrest assembly of any preceding embodiment; and a seat back coupled with the headrest assembly; wherein the guide sleeve is disposed at least partially in and fixed to the seat back; and the second connector is disposed in the seat back.

A method of assembling the headrest assembly of any preceding embodiment, the method comprising: coupling the first connector with the headrest; inserting the post into a first end of the guide sleeve; inserting the first connector into the second connector; and sliding the retainer from a pre-locked position to a locked position to lock the first connector with the second connector.

The method of any preceding embodiment, wherein the first connector is coupled with the headrest prior to inserting the post into the first end of the guide sleeve.

The method of any preceding embodiment, further comprising, after coupling the first connector with the headrest and before inserting the first connector into the second connector, coupling the guide sleeve with a seat back of a seat.

The method of any preceding embodiment, further comprising, before inserting the first connector into the second connector, coupling the guide sleeve with a seat back of a seat.

The method of any preceding embodiment, wherein inserting the first connector into the second connector includes: inserting the plurality of second terminals into the plurality of first terminals; and the first connector deflecting an arm of the retainer to facilitate the sliding of the retainer to the locked position.

The method of any preceding embodiment, further comprising limiting, via contact between the arm and a stop surface of the second connector, sliding of the retainer to the locked position prior to the insertion of the first connector into the second connector.

The method of any preceding embodiment, further comprising limiting, via contact between the retainer and a latch of the second connector, sliding movement of the retainer from the locked position to the pre-locked position.

The method of any preceding embodiment, further comprising inserting the first connector through the post.

The method of any preceding embodiment, wherein inserting the first connector through the post includes pulling the first connector through the post with an assembly tool comprising a clip engaged with the first connector and a wire coupled to the clip.

The headrest assembly of any preceding embodiment, wherein an outer diameter of the first connector is less than 16 mm and greater than or equal to 14 mm.

The headrest assembly of any preceding embodiment, wherein an outer diameter of the first connector is less than 16 mm and greater than or equal to 13 mm.

The headrest assembly of any preceding embodiment, wherein the outer diameter of the first connector is less than 14 mm.

The headrest assembly of any preceding embodiment, wherein the outer diameter of the first connector is at least 15.3 mm and less than or equal to 15.7 mm.

The headrest assembly of any preceding embodiment, wherein the plurality of first terminals includes at least 8 first terminals and less than or equal to 14 first terminals.

The headrest assembly of any preceding embodiment, wherein the plurality of first terminals includes at least 10 first terminals and less than or equal to 14 first terminals.

The headrest assembly of any preceding embodiment, wherein the plurality of first terminals includes 9 first terminals.

The headrest assembly of any preceding embodiment, wherein the plurality of first terminals includes 14 first terminals.

The headrest assembly of any preceding embodiment, wherein the first connector includes a front surface that faces the second connector, a terminal aperture for each of the plurality of first terminals, and a release aperture for each of the plurality of first terminals; and the terminal apertures and the release apertures extend to the front surface.

The headrest assembly of any preceding embodiment, wherein at least one of the plurality of first terminals is configured for use with higher electrical current than at least one other first terminal of the plurality of first terminals.

The headrest assembly of any preceding embodiment, wherein the retainer includes a pre-locked position and a locked position; the retainer includes a flexible arm; and the second connector includes a stop surface configured to contact the flexible arm to restrict movement of the retainer from the pre-locked position to the locked position.

The headrest assembly of any preceding embodiment, wherein the first connector includes a latch protrusion; and the second connector includes a flexible latch configured to engage the latch protrusion to latch the first connector with the second connector.

The headrest assembly of any preceding embodiment, wherein the retainer includes a projection; and in the locked position of the retainer, the projection restricts disengagement of the flexible latch from the latch protrusion.

The headrest assembly of any preceding embodiment, wherein the first connector includes a retainer protrusion configured to deflect the flexible arm at least partially out of alignment with the stop surface to facilitate sliding movement of the retainer from the pre-locked position to the locked position.

The headrest assembly of any preceding embodiment, wherein the first connector includes a body comprising a round configuration with a flat portion parallel to a centerline of the body; and the latch protrusion and the retainer protrusion extend from the flat portion.

The headrest assembly of any preceding embodiment, wherein the body includes the flat portion and an alignment recess that opens radially outward; and the second connector includes an alignment protrusion corresponding to the alignment recess.

A seat assembly comprising: the headrest assembly of any preceding embodiment; and a seat back coupled with the headrest assembly; wherein the guide sleeve is disposed at least partially in and fixed to the seat back; and the second connector is disposed in the seat back.

A method of assembling the headrest assembly of any preceding embodiment, the method comprising: coupling the first connector with the headrest; inserting the post into a first end of the guide sleeve; inserting the first connector into the second connector; and sliding the retainer from a pre-locked position to a locked position to lock the first connector with the second connector.

The method of any preceding embodiment, wherein the first connector is coupled with the headrest prior to inserting the post into the first end of the guide sleeve.

The method of any preceding embodiment, wherein the first connector is coupled with the headrest after inserting the post into the first end of the guide sleeve.

The method of any preceding embodiment, further comprising, after coupling the first connector with the headrest and before inserting the first connector into the second connector, coupling the guide sleeve with a seat back of a seat.

The method of any preceding embodiment, wherein inserting the first connector into the second connector includes: inserting the plurality of second terminals into the plurality of first terminals; and the first connector deflecting an arm of the retainer to facilitate the sliding of the retainer to the locked position.

The method of any preceding embodiment, wherein the plurality of first terminals includes at least 10 first terminals and less than or equal to 14 terminals; and an outer diameter of the first connector is less than 16 mm and greater than or equal to 14 mm.

The method of any preceding embodiment, further comprising limiting, via contact between the arm and a stop surface of the second connector, sliding of the retainer to the locked position prior to the insertion of the first connector into the second connector.

The method of any preceding embodiment, further comprising limiting, via contact between the retainer and a latch of the second connector, sliding movement of the retainer from the locked position to the pre-locked position.

A vehicle comprising the headrest assembly of any preceding embodiment.

A vehicle comprising the seat assembly of any preceding embodiment.

In examples, a controller (e.g., the electronic controller 32) may include an electronic controller and/or include an electronic processor, such as a programmable microprocessor and/or microcontroller. In embodiments, a controller may include, for example, an application specific integrated circuit (ASIC) and/or an embedded controller. A controller may include a central processing unit (CPU), a memory (e.g., a non-transitory computer-readable storage medium), and/or an input/output (I/O) interface. A controller may be configured to perform various functions, including those described in greater detail herein, with appropriate programming instructions and/or code embodied in software, hardware, and/or other medium. In embodiments, a controller may include a plurality of controllers. In embodiments, a controller may be connected to a display, such as a touchscreen display.

Various examples/embodiments are described herein for various apparatuses, systems, and/or methods. Numerous specific details are set forth to provide a thorough understanding of the overall structure, function, manufacture, and use of the examples/embodiments as described in the specification and illustrated in the accompanying drawings. It will be understood by those skilled in the art, however, that the examples/embodiments may be practiced without such specific details. In other instances, well-known operations, components, and elements have not been described in detail so as not to obscure the examples/embodiments described in the specification. Those of ordinary skill in the art will understand that the examples/embodiments described and illustrated herein are non-limiting examples, and thus it can be appreciated that the specific structural and functional details disclosed herein may be representative and do not necessarily limit the scope of the embodiments.

Reference throughout the specification to “examples, “in examples,” “with examples,” “in the illustrated example,” “various embodiments,” “with embodiments,” “in embodiments,” “an embodiment,” “with some configurations,” “in some configurations,” or the like, means that a particular feature, structure, or characteristic described in connection with the example/embodiment is included in at least one embodiment. Thus, appearances of the phrases “examples, “in examples,” “with examples,” “in the illustrated example,” “in various embodiments,” “with embodiments,” “in embodiments,” “an embodiment,” “with some configurations,” “in some configurations,” or the like, in places throughout the specification are not necessarily all referring to the same embodiment. Furthermore, the particular features, structures, and/or characteristics may be combined in any suitable manner in one or more examples/embodiments. Thus, the particular features, structures, or characteristics illustrated or described in connection with one embodiment/example may be combined, in whole or in part, with the features, structures, functions, and/or characteristics of one or more other embodiments/examples without limitation given that such combination is not illogical or non-functional. Moreover, many modifications may be made to adapt a particular situation or material to the teachings of the present disclosure without departing from the scope thereof. The word “exemplary” is used herein to mean “serving as a non-limiting example.”

It should be understood that references to a single element are not necessarily so limited and may include one or more of such element, unless the context clearly indicates otherwise. Any directional references (e.g., plus, minus, upper, lower, upward, downward, left, right, leftward, rightward, top, bottom, above, below, vertical, horizontal, clockwise, and counterclockwise) are only used for identification purposes to aid the reader's understanding of the present disclosure, and do not create limitations, particularly as to the position, orientation, or use of examples/embodiments.

“One or more” includes a function being performed by one element, a function being performed by more than one element, e.g., in a distributed fashion, several functions being performed by one element, several functions being performed by several elements, or any combination of the above. The term “at least one of” in the context of, e.g., “at least one of A, B, and C” or “at least one of A, B, or C” includes only A, only B, only C, or any combination or subset of A, B, and C, including any combination or subset of one or a plurality of A, one or a plurality of B, and one or a plurality of C. A “set” of elements can include any number of one or more elements.

Although the terms first, second, etc. are, in some instances, used herein to describe various elements, these elements should not be limited by these terms. These terms are only used to distinguish one element from another. For example, a first element could be termed a second element, and, similarly, a second element could be termed a first element, without departing from the scope of the various described embodiments. The first element and the second element are both elements, but they are not the same element.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. The term “and/or” as used herein refers to and encompasses any and all possible combinations of one or more of the associated listed items. Uses of “and” and “or” are to be construed broadly (e.g., to be treated as “and/or”). For example and without limitation, uses of “and” do not necessarily require all elements or features listed, and uses of “or” are inclusive unless such a construction would be illogical. The terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

Joinder references (e.g., attached, coupled, connected, and the like) are to be construed broadly and may include intermediate members between a connection of elements, relative movement between elements, direct connections, indirect connections, fixed connections, movable connections, operative connections, indirect contact, and/or direct contact. As such, joinder references do not necessarily imply that two elements are directly connected/coupled and in fixed relation to each other. Connections of electrical components, if any, may include mechanical connections, electrical connections, wired connections, and/or wireless connections, among others. Uses of “e.g.” and “such as” in the specification are to be construed broadly and are used to provide non-limiting examples of embodiments of the disclosure, and the disclosure is not limited to such examples.

While processes, systems, and methods may be described herein in connection with one or more steps in a particular sequence, such methods may be practiced with the steps in a different order, with certain steps performed simultaneously, with additional steps, and/or with certain described steps omitted.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

References to a vehicle can include one or more of a variety of vehicles, including, without limitation, a passenger car (e.g., a sedan, a pickup truck, a sport utility vehicle, a crossover, etc.), a truck, a bus, a plane, or a boat, among others.

All matter contained in the above description or shown in the accompanying drawings shall be interpreted as illustrative only and not limiting. Changes in detail or structure may be made without departing from the present disclosure.

What is claimed is:

1. A headrest assembly, comprising:
a headrest comprising a post;
a guide sleeve configured to at least partially receive the post; and
an electrical assembly comprising:
a first connector configured to slide within the guide sleeve;
a plurality of first terminals disposed at least partially in the first connector;
a second connector configured to engage the first connector;
a plurality of second terminals disposed at least partially in the second connector and configured to engage the plurality of first terminals; and
a retainer slidably coupled with the second connector and configured to lock the first connector with the second connector.

2. The headrest assembly of claim 1, wherein the first connector is configured to slide within the post.

3. The headrest assembly of claim 1, further comprising:
a second retainer disposed at least partially in the first connector and restricting movement of the plurality of first terminals relative to the first connector; and
a third retainer disposed at least partially in the second connector and restricting movement of the plurality of second terminals relative to the second connector.

4. The headrest assembly of claim 1, wherein an outer diameter of the first connector is less than an inner diameter of the post.

5. The headrest assembly of claim 4, wherein the outer diameter of the first connector is less than 10 mm and greater than or equal to 7 mm.

6. The headrest assembly of claim 5, wherein the plurality of first terminals includes four first terminals.

7. The headrest assembly of claim 1, wherein the retainer includes a pre-locked position and a locked position;
the retainer includes a flexible arm; and
the second connector includes a stop surface configured to contact the flexible arm to restrict movement of the retainer from the pre-locked position to the locked position.

8. The headrest assembly of claim 7, wherein the first connector includes a latch protrusion; and
the second connector includes a flexible latch configured to engage the latch protrusion to latch the first connector with the second connector.

9. The headrest assembly of claim 8, wherein the retainer or the second connector includes a projection; and
in the locked position of the retainer, the projection restricts disengagement of the flexible latch from the latch protrusion.

10. The headrest assembly of claim 9, wherein the first connector includes a retainer protrusion configured to deflect the flexible arm at least partially out of alignment with the stop surface to facilitate sliding movement of the retainer from the pre-locked position to the locked position.

11. A seat assembly comprising:
the headrest assembly of claim 1; and
a seat back coupled with the headrest assembly;
wherein the guide sleeve is disposed at least partially in and fixed to the seat back; and
the second connector is disposed in the seat back.

12. A vehicle comprising the seat assembly of claim 11.

13. A method of assembling the headrest assembly of claim 1, the method comprising:
coupling the first connector with the headrest;
inserting the post into a first end of the guide sleeve;
inserting the first connector into the second connector; and
sliding the retainer from a pre-locked position to a locked position to lock the first connector with the second connector.

14. The method of claim 13, wherein the first connector is coupled with the headrest prior to inserting the post into the first end of the guide sleeve.

15. The method of claim 13, further comprising, after coupling the first connector with the headrest and before inserting the first connector into the second connector, coupling the guide sleeve with a seat back of a seat.

16. The method of claim 13, wherein inserting the first connector into the second connector includes:
inserting the plurality of second terminals into the plurality of first terminals; and
the first connector deflecting an arm of the retainer to facilitate the sliding of the retainer to the locked position.

17. The method of claim 16, further comprising limiting, via contact between the arm and a stop surface of the second connector, sliding of the retainer to the locked position prior to the insertion of the first connector into the second connector.

18. The method of claim 17, further comprising limiting, via contact between the retainer and a latch of the second connector, sliding movement of the retainer from the locked position to the pre-locked position.

19. The method of claim 13, further comprising inserting the first connector through the post.

20. The method of claim 19, wherein inserting the first connector through the post includes pulling the first connector through the post with an assembly tool comprising a clip engaged with the first connector and a wire coupled to the clip.
